(19) United States
(12) Patent Application Publication
(10) Pub. No.: US 2026/0170490 A1
(43) Pub. Date: Jun. 18, 2026

(54) GENERATING TRANSACTION LINKS FOR INITIATING BLOCKCHAIN TRANSACTIONS

(71) Applicant: Coinbase, Inc., Oakland, CA (US)

(72) Inventors: Jeffrey Daniel Hinojosa, Woodland Hills, CA (US); Cody Crozier, Phoenix, AZ (US); Wilson Cusack, Sunnyvale, CA (US); Arjun Dureja, Mississauga (CA)

(21) Appl. No.: 18/979,546

(22) Filed: Dec. 12, 2024

(51) Int. Cl. G06Q 20/38; G06Q 20/40; H04L 9/08; H04L 9/32

(52) U.S. Cl. CPC G06Q 20/3825; G06Q 20/3823; G06Q 20/3829; G06Q 20/401; H04L 9/0825; H04L 9/3247

(57) ABSTRACT

Methods, systems, and devices for data management are described. The described techniques may enable a user of a custodial token platform to generate a transaction link that may initiate a blockchain transaction to transfer an amount of crypto token to a destination address. For example, the user may provide a signature, the destination address, and other data associated with the transaction to a client application. The client application may generate a link that encodes the destination address, the signature, and/or the data. The user may accordingly provide the link to the one or more other users. In response to the one or more other users selecting the link, the client application may prompt the one or more other users to authorize the transaction and may accordingly cause the transfer of the amount of token to the destination address.

### FIELD OF TECHNOLOGY

The present disclosure relates generally to data management, including techniques for generating transaction links for initiating blockchain transactions.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports generating transaction links for initiating blockchain transactions in accordance with aspects of the present disclosure.

FIG. 2 shows an example of a computing environment that supports generating transaction links for initiating blockchain transactions in accordance with aspects of the present disclosure.

FIG. 3 shows an example of a graphical user interface (GUI) diagram that supports generating transaction links for initiating blockchain transactions in accordance with aspects of the present disclosure.

FIG. 4 shows an example of a GUI diagram that supports generating transaction links for initiating blockchain transactions in accordance with aspects of the present disclosure.

FIG. 5 shows an example of a process flow that supports generating transaction links for initiating blockchain transactions in accordance with aspects of the present disclosure.

FIG. 6 shows an example of a process flow that supports generating transaction links for initiating blockchain transactions in accordance with aspects of the present disclosure.

FIG. 7 shows a block diagram of an apparatus that supports generating transaction links for initiating blockchain transactions in accordance with aspects of the present disclosure.

FIG. 8 shows a block diagram of a client application that supports generating transaction links for initiating blockchain transactions in accordance with aspects of the present disclosure.

FIG. 9 shows a diagram of a system including a device that supports generating transaction links for initiating blockchain transactions in accordance with aspects of the present disclosure.

FIGS. 10 and 11 show flowcharts illustrating methods that support generating transaction links for initiating blockchain transactions in accordance with aspects of the present disclosure.

### DETAILED DESCRIPTION

A user of a blockchain address application may desire to enable one or more other users to transfer funds to a destination address of the user, such as a blockchain wallet of the user (e.g., for funding for a non-fungible token (NFT)). For example, the user may provide a service to the one or more other users, and may accept payment or tips via transfer of the funds to the destination address. However, some systems may require the payor to enter the recipient address, fill in information (e.g., an amount), and sign and execute the transaction. These techniques may be associated with a decreased user experience and may result in the payor just skipping payment or tipping.

Techniques described herein may support a user generating a link (e.g., a transaction link) that may initiate a transaction to transfer funds (e.g., crypto token) to the destination address without reduced involvement from users. For example, the user may provide an authorization (e.g., a signature), the destination address, and/or data associated with the transaction (e.g., an amount of token to transfer, a chain identifier (ID), a network identifier, and the like) to a client application (e.g., a Dapp). The client application may generate a link that encodes the destination address, the signature, and/or the data. The user may accordingly provide the link to the one or more other users (e.g., via a website, social network). In response to selecting the link by a user, a client application may automatically populate information associated with the transaction (e.g., amount, destination address) and may prompt users to authorize (e.g., sign) the transaction and may accordingly cause the transfer of the amount of token to the destination address.

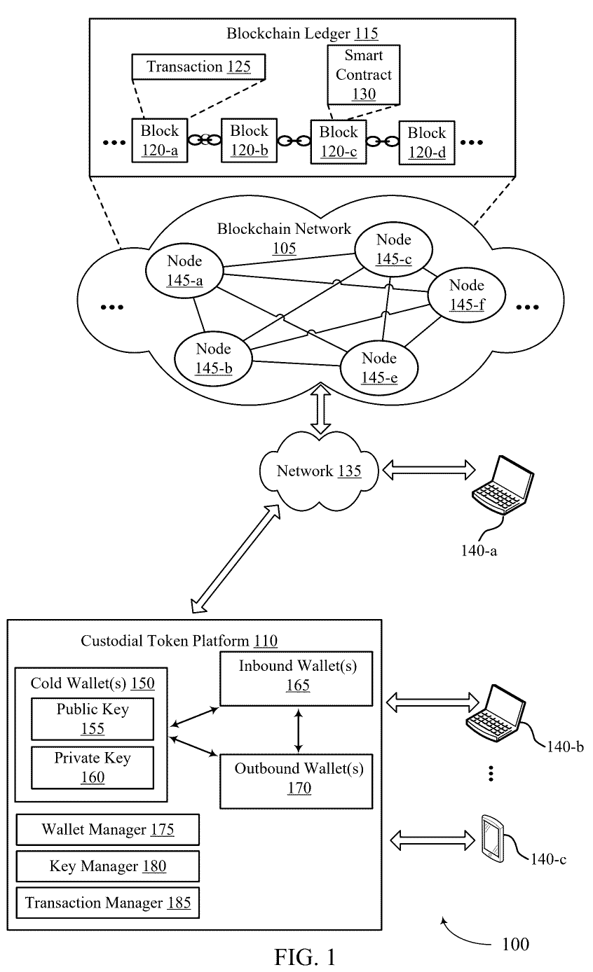

FIG. 1 illustrates an example of a computing environment 100 that supports generating transaction links for initiating blockchain transactions in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the mart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples of the computing environment 100, a user may open a smart wallet associated with the custodial token platform 110. The smart wallet may be a wallet associated with a blockchain address via which the user may transfer crypto tokens as described herein. In some examples, the smart wallet may be configured to connect to a plurality of client applications (e.g., Dapps). For example, the client applications may install an SDK associated with the custodial token platform 110 that may enable connection to the smart wallet. The user may accordingly use funds of the smart wallet to perform one or more purchases associated with the one or more client applications. Smart wallets, as described herein, may be passkey-based wallets. A passkey may be an example of a digital credential bound to a user account, such as an email account, or a hardware device and a website or application, such as a client application or a blockchain address application as described herein. In other words, passkeys may be associated with user accounts or hardware devices and may be uniquely bound to a domain. For example, passkeys may be stored at a location that is associated with the user account or hardware device (e.g., in a secure enclave, a cloud, on the hardware device, etc.). Additionally, passkeys may be usable on the domain that they are bound to (e.g., and not on other domains). Creating a smart wallet may involve creating a passkey. For example, a user may create a passkey bound to a user account (e.g., of the client application, or a different account) and bound to a domain of the client application. The passkey may be used to encrypt a private key. Additionally, smart wallets may not involve recovery phrases (e.g., recovery phrases for externally owned account (EOA) wallets).

In some examples of the computing environment 100, a user (e.g., of the custodial token platform 110) may generate a link (e.g., a transaction link) that may be used to initiate a transaction to transfer funds (e.g., crypto token) to a destination address (e.g., an address associated with the user or an address associated with another user or entity). For example, the user may provide an authorization (e.g., a signature), the destination address, and/or data associated with the transaction (e.g., an amount of token to transfer, a chain identifier (ID), a network identifier, and the like) to a client application (e.g., a Dapp). The client application may generate a link that encodes the destination address, the signature, and/or the data into a link (e.g., a uniform resource locator (URL)). The user may accordingly provide or share the link to the one or more other users. In response to selection of the link by the one or more other users, the client application may populate a transaction and prompt the one or more other users to authorize the transaction, which may cause the transfer of the amount of token to the destination address.

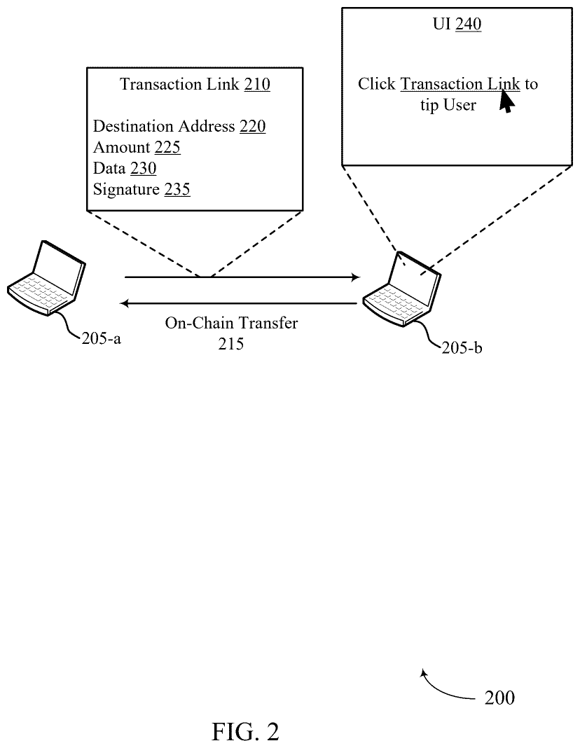

FIG. 2 shows an example of a computing environment 200 that supports generating transaction links for initiating blockchain transactions in accordance with aspects of the present disclosure. The computing environment 200 may implement or may be implemented by aspects of the computing environment 100. For example, the computing environment 200 may be implemented by one or more user devices 140 (e.g., a user device 205-a, a user device 205-b) and/or a custodial token platform 110 as described with reference to FIG. 1.

In some examples of the computing environment 200, a user of a blockchain address application (e.g., a custodial token platform 110) may create, via a client application (e.g., the blockchain address application or another application), a transaction link 210 that may be used to initiate transfer of an amount 225 of crypto token to a destination address 220. For example, the transaction link 210 may initiate a broadcast of one or more blockchain messages that may cause the amount 225 of crypto token to be transferred from a wallet of another user (e.g., a user of a user device 205-b) to a destination address 220 provided by the user (e.g., a user of a user device 205-a).

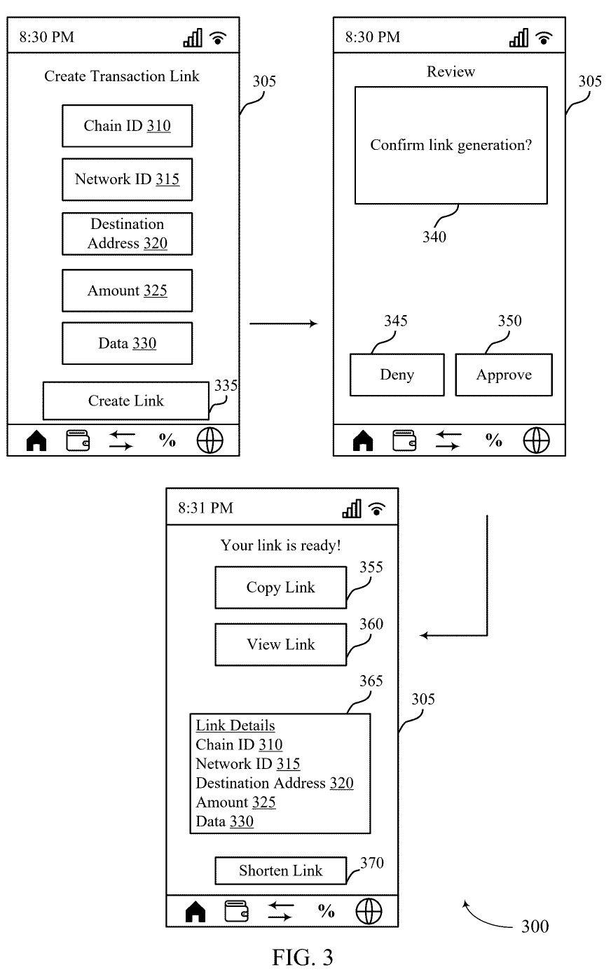

For example, as illustrated with reference to FIG. 3, the client application may display a GUI including one or more fields in which the user may input data 230 associated with a blockchain transaction (e.g., an on-chain transfer 215). The user may input one or more of the destination address 220 (e.g., an address associated with the user, an address associated with another user, an address associated with funding of an NFT such as an NFT minting contract), the amount 225 (e.g., a value), and additional data 230 such as data associated with a smart contract call (e.g., an ID of a smart contract), a function call to be executed by the smart contract, a chain ID, a network ID, a paymaster service (e.g., a service that may sponsor a transaction fee or gas fee for the on-chain transfer 215), and the like. The user may provide a signature 235 (e.g., via the blockchain address application), such as a signature 235 associated with a private key or passkey of the user.

The client application may accordingly generate the transaction link 210. For example, the client application may encode some or all of the data 230 (e.g., the destination address 220, the amount 225) and the signature 235 associated with the user into the transaction link 210. The encoded signature 235 may prevent an unauthorized user from tampering with the transaction link 210. For example, if the unauthorized user adjusts one or more values of the transaction link 210 to indicate a different address (e.g., an address different from the destination address 220), the signature may prevent the tampered link from initiating the broadcast of one or more blockchain messages to cause a transfer of the amount 225 of crypto token to the different address.

In some examples, the user may view or copy the generated transaction link 210. For example, the user may view or copy the data 230 associated with the on-chain transfer 215 that is encoded in the transaction link 210. Additionally, or alternatively, the client application may shorten the transaction link 210 (e.g., in response to a request from the user to shorten the transaction link 210). The client application may generate a shortened transaction link that may include a randomized value associated with the destination address 220, the signature 235, the amount 225, the data 230, and so on.

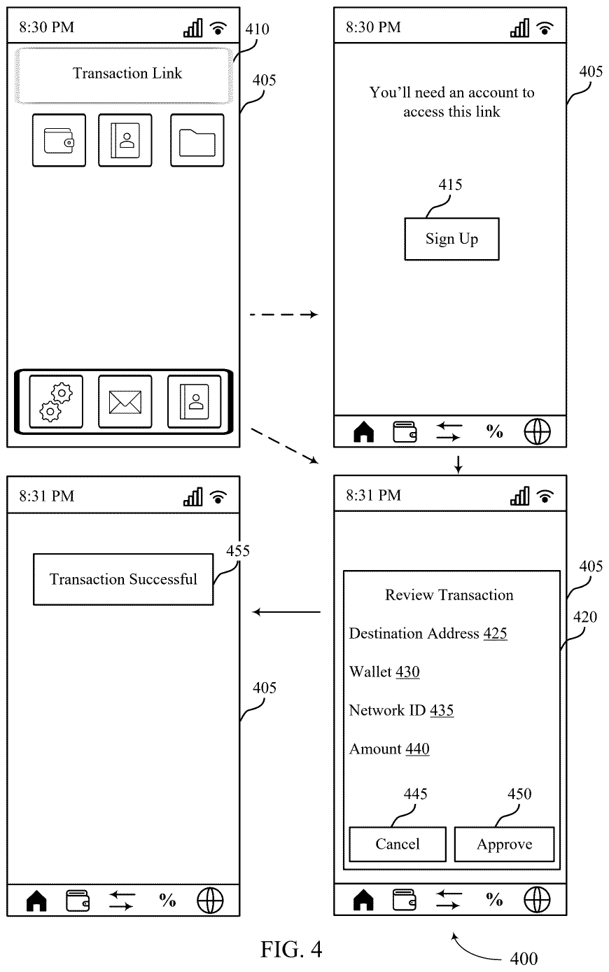

The transaction link 210 and the shortened transaction link may be configured to initiate the broadcast of the one or more blockchain messages in response to selection by another user of the transaction link 210 or the shortened transaction link (e.g., as illustrated with reference to FIG. 4). For example, the user may provide the transaction link 210 to another user (e.g., the user of the user device 205-b) via a message, email, social network, website etc. As illustrated in a user interface (UI) 240, the other user may select the transaction link, which may cause the client application to display a blockchain address application to initiate the transfer.

In some examples, if the other user has a blockchain address associated with the blockchain address application (e.g., a smart wallet), the blockchain address application may prompt the other user to provide an authorization (e.g., a signature) to broadcast the one or more blockchain messages to cause the on-chain transfer 215 (e.g., to transfer the amount 225 of token from the blockchain address of the other user to the destination address 220). The smart wallet may enable the broadcast of the one or more blockchain messages as a result of the smart wallet being a web-based wallet. That is, the web-based nature of the smart wallet may allow the parameters encoded in the transaction link 210 to be used to cause the broadcast of the one or more blockchain messages.

Additionally, or alternatively, if the other user does not have a blockchain address associated with the blockchain address application (e.g., a smart wallet), the blockchain address application may prompt the other user to generate and fund a blockchain address. For example, the blockchain address application may prompt the user to create a smart wallet and transfer funds (e.g., the amount 225 of token) to the created smart wallet. The blockchain address application may accordingly prompt the other user to provide an authorization (e.g., a signature) to broadcast the one or more blockchain messages to cause the on-chain transfer 215 (e.g., to transfer the amount 225 of token from the blockchain address of the other user to the destination address 220).

Additionally, or alternatively, if the other user has a blockchain address associated with the blockchain address application (e.g., a smart wallet) and the blockchain address is associated with relatively less funds than the amount 225 indicated by the transaction link 210, the blockchain address application may prompt the other user fund the blockchain address. For example, the blockchain address application may prompt the user to transfer and/or purchase funds (e.g., the amount 225 of token) to the smart wallet. The blockchain address application may accordingly prompt the other user to provide an authorization (e.g., a signature) to broadcast the one or more blockchain messages to cause the on-chain transfer 215 (e.g., to transfer the amount 225 of token from the blockchain address of the other user to the destination address 220).

In some examples, the client application may perform one or more verifications (e.g., prior to initiating the on-chain transfer 215). For example, the client application may verify that the signature 235 encoded in the transaction link 210 is the same signature as the signature provided by the user to authorize creation of the transaction link. Additionally, or alternatively, the client application may verify that the destination address 220 encoded in the transaction link and/or the blockchain address associated with the other user (e.g., the smart wallet) are not included in a blacklist of the client application (e.g., a list of accounts that are disabled from creating or using transaction links 210). Additionally, or alternatively, the client application may verify that the amount 225 is less than a threshold amount (e.g., a value limit). If one or more of the verifications is not successful (e.g., if the signature 235 encoded in the transaction link 210 is not a same signature as the signature provided by the user to authorize creation of the transaction link, if the destination address 220 or the blockchain address are included in the blacklist, if the amount 225 is greater than the threshold amount), the client application may refrain from initiating the on-chain transfer 215 (e.g., the broadcast of the one or more blockchain messages to cause the transfer of the amount 225 of token from the blockchain address to the destination address 220).

In some examples, the client application may store the transaction link 210 (e.g., in a database accessible by the user of the user device 205-a). For example, the client application may store a history of transaction links 210 generated by the user, such as via a user interface indicating each created transaction link 210 and/or a date associated with generation of each transaction link 210. The user may accordingly view and/or copy previously-generated transaction links 210.

In some examples, the user may request deactivation of the transaction link 210. For example, the user may request for the client application to cause a previously-generated transaction link 210 to cease initiating the broadcast of the blockchain messages. Additionally, or alternatively, the user may provide a request for the transaction link 210 to expire (e.g., after an amount of time indicated by the user). In such examples, the client application may remove the deactivated transaction link 210 from the database. In some examples, the client application may store one or more deactivated transaction links 210 in an additional database.

FIG. 3 shows an example of a GUI diagram 300 that supports generating transaction links for initiating blockchain transactions in accordance with aspects of the present disclosure. The GUI diagram 300 may implement or may be implemented by aspects of the computing environment 100 or the computing environment 200. For example, the GUI diagram 300 may be implemented by one or more user devices 140 and custodial token platforms 110 as described with reference to FIG. 1.

As illustrated with reference to the GUI diagram 300, a client application of a user device 305 may enable the user to generate a transaction link configured to cause a broadcast of one or more blockchain messages to transfer an amount of crypto token to a blockchain address. For example, the client application may display a user interface including one or more fields via which a user may input data associated with a blockchain transaction. For example, the user may input a chain ID 310, a network ID 315, a destination address 320 (e.g., an address of a blockchain wallet associated with the user or another user), an amount 325 of crypto token to transfer, and any additional data 330.

The user may provide a user input (e.g., a selection 335 of the user interface) to initiate the generation of the transaction link using the provided data. In response to the user input, the client application may display a review page indicating a prompt 340 for the user to confirm generation of the transaction link. The prompt 340 may include a display of a message, such as some or all of the data 330 indicated by the user. The user may accordingly verify that the link to be generated includes correct data (e.g., a correct destination address 320). In some examples, the user may provide a selection 345 to deny generation of the transaction link. In such examples, the client application may refrain from generating the transaction link and may return to a previous user interface page (e.g., the user interface including the one or more fields).

Additionally, or alternatively, the user may provide a selection 350 to approve the generation of the transaction link. In such examples, the user may provide a signature (e.g., a signature associated with a private key of the user) that authorizes the link generation. For example, the client application may provide a transaction payload to a blockchain address application (e.g., an application associated with a blockchain wallet of the user), and the blockchain address application may provide a signed transaction payload (e.g., signed via the private key).

In response to receiving the authorization, the client application may generate the transaction link (e.g., by encoding the data, such as the destination address 320, and the signature). In some examples, the user may provide a selection 355 to copy the link (e.g., to a clipboard associated with the user device 305 for pasting into another application), a selection 360 to view the transaction link, one or more details 365 of the transaction link (e.g., the chain ID 310, the network ID 315, the destination address 320, the amount 325, and/or the additional data 330.

In some examples, the user may provide a selection 370 requesting for the client application to shorten the transaction link. In such examples, the client application may generate a shortened transaction link that may be configured to cause the broadcast of the blockchain messages. The shortened transaction link may include a randomized value associated with the data and the signature. The client application may display a user interface configured to enable the user to copy and/or view the shortened transaction link. The user may share the transaction link to other users using various techniques, such as social media, adding the link to a website, sharing via email, or the like.

FIG. 4 shows an example of a GUI diagram 400 that supports generating transaction links for initiating blockchain transactions in accordance with aspects of the present disclosure. The GUI diagram 400 may implement or may be implemented by aspects of the computing environment 100, the computing environment 200, or the GUI diagram 300. For example, the GUI diagram 400 may be implemented by one or more user devices 140 and custodial token platforms 110 as described with reference to FIG. 1.

As illustrated with reference to the GUI diagram 400, a user device 405 may be configured to initiate a blockchain transaction in response to selection of a transaction link 410. For example, the transaction link 410 may be encoded with information to cause transfer of an amount 440 of crypto token from a blockchain address (e.g., a smart wallet) associated with a user to a destination address 425 associated with a transaction link 410. In some examples, the transaction link 410 may encode the destination address 425, a signature associated with generation of the transaction link, and/or other data associated with the transaction link.

For example, the user may select the transaction link 410. The transaction link 410 may cause the user device 405 to display a user interface of a blockchain address application. In some examples, if the user is associated with a wallet 430 or blockchain address (e.g., a smart wallet) of the blockchain address application, the blockchain address application may display a page indicating information 420 associated with the blockchain transaction. The information 420 may include the destination address 425 (e.g., a destination address that may be associated with a same user or a different user as the signature), an ID associated with the wallet 430 of the user, a network ID 435, and the amount 440 of crypto to be transferred from the wallet 430 to the destination address 425 as part of the blockchain transaction.

Additionally, or alternatively, if the user is not associated with a blockchain address (e.g., a smart wallet) of the blockchain address application, the blockchain address application may display a request 415 for the user to create a wallet 430 (e.g., to create and fund a blockchain address such as a smart wallet associated with the blockchain address application). For example, the blockchain address application may instruct the user to purchase or transfer an amount of crypto token to fund the wallet 430 that is greater than or equal to the amount 440. The blockchain address application may display the information 440 associated with the blockchain transaction in response to the user creating and funding a blockchain address (e.g., a smart wallet).

In some examples (e.g., if the transaction link does not encode the amount 440), the client application and/or the blockchain address application may display a user interface including a field in which the user may enter an amount of token to transfer to the destination address 425.

The user may provide a selection 445 to cancel the blockchain transaction. In such examples, the blockchain address application may refrain from broadcasting the one or more messages. Additionally, or alternatively, the user may provide a selection 450 to approve the blockchain transaction. For example, the user may provide an approval (e.g., a signature) for the blockchain address application to broadcast the one or more messages.

The blockchain address application may broadcast the one or more messages to cause transfer of the amount 440 of token from the wallet 430 to the destination address 425 in response to receiving the approval from the user. In some examples, in response to success of the blockchain transaction, the blockchain address application may display a message 455 to the user indicating completion of the blockchain transaction.

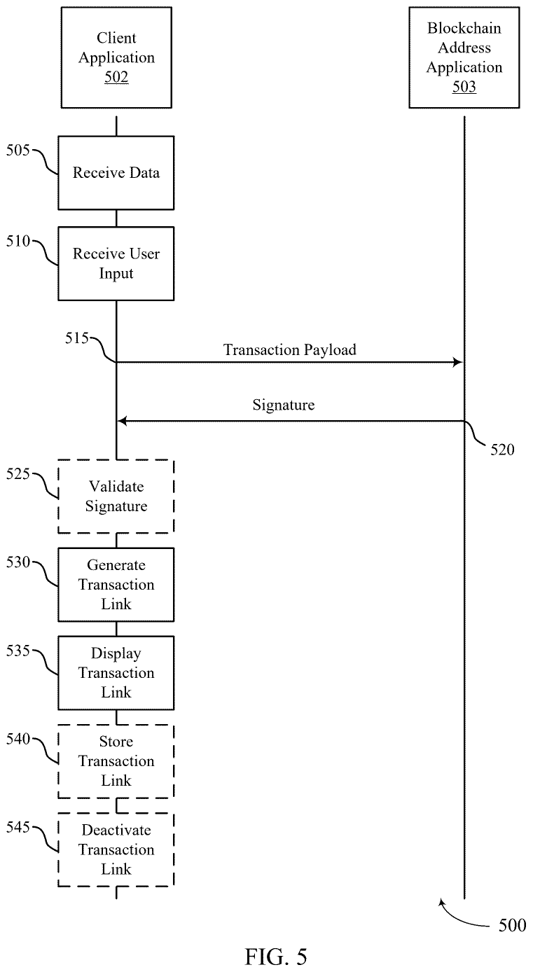

FIG. 5 shows an example of a process flow 500 that supports generating transaction links for initiating blockchain transactions in accordance with aspects of the present disclosure. The process flow 500 may implement or may be implemented by aspects of the computing environment 100, the computing environment 200, the GUI diagram 300, or the GUI diagram 400. For example, the process flow 500 may be implemented by a client application 502 and a blockchain address application 503, which may be implemented by a user device 140 as described with reference to FIG. 1.

In the following description of the process flow 500, the operations between the client application 502 and the blockchain address application 503 may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time. Although the blockchain address application 503 and the client application 502 are illustrated herein as separate applications, the blockchain address application 503 and the client application 502 may be a same application.

At 505, the client application 502 may receive, from a user and via one or more fields of the client application 502, data associated with a blockchain transaction. The data may include a destination address (e.g., a destination address associated with a smart contract, a first blockchain address of the blockchain address application 503, or a blockchain address associated with another entity), an ID of the smart contract, an amount of crypto token to transfer via the blockchain transaction, a chain ID, and/or a network ID.

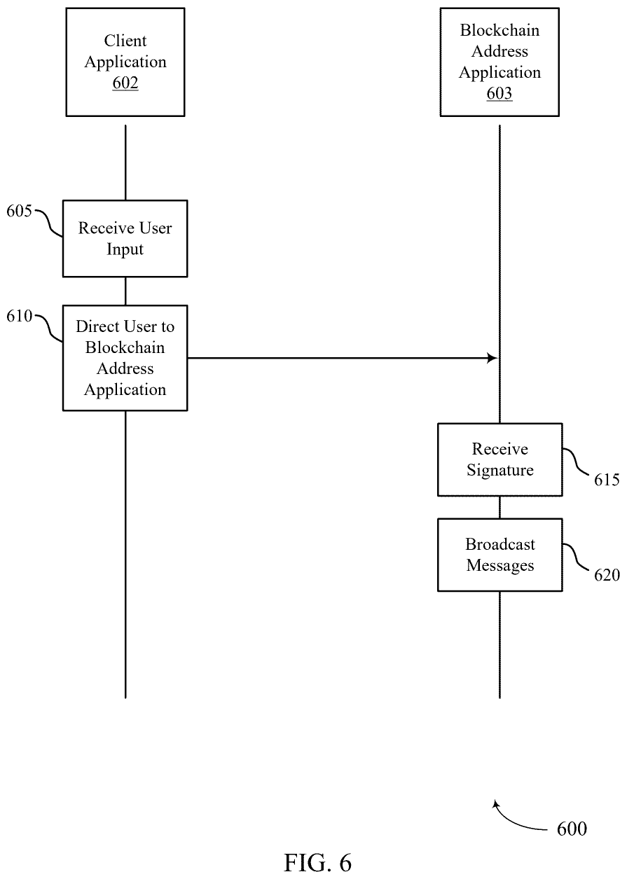

At 510, the client application 502 may receive a user input requesting to generate a transaction link associated with the blockchain transaction. For example, the transaction link may encode some or all of the data associated with the blockchain transaction and/or a signature of the user authorizing the blockchain transaction. The transaction link may be configured to cause a transfer of an amount of crypto token from a smart wallet associated with a second user to the destination address in response to selection by the second user of the transaction link, as described with reference to FIG. 6. In some examples, the client application 502 may receive a second user input indicating a blockchain address of the blockchain application 503 that is to sign a transaction payload.

At 515, the client application 502 may output, to the blockchain address application 503 the transaction payload for signature by the blockchain address application 503. For example, the client application 502 may output the transaction payload in response to the first or second user inputs. The blockchain address application 503 may sign the transaction payload (e.g., via a private key of the blockchain address application) and, at 520, the blockchain address application may output the signature associated with signing the transaction payload to the client application 502.

In some examples, at 525, the client application 502 may validate the signature. For example, the client application 502 may validate that the signature corresponds to the blockchain address application 503 and that the destination address is not on a blacklist of blockchain addresses.

In some examples, at 530, the client application 502 may generate the transaction link. For example, the client application 502 may encode the data associated with the transaction and/or the signature into the transaction link. In some examples, the client application 502 may generate a shortened version of the transaction link. For example, the client application 502 may generate a randomized value associated with the data and the signature. The shortened transaction link may be configured to initiate broadcast of one or more messages to cause the transfer of the token, as described with reference to FIG. 6.

At 535, the client application 502 may display the transaction link (e.g., via a GUI). For example, the client application 502 may display a user interface (e.g., a GUI) including the data associated with the blockchain transaction, a user interface component configured for copying the transaction link or the shortened transaction link, a user interface component configured causing the client application 502 to generate the shortened transaction link, and/or a user interface component for viewing the transaction link or the shortened transaction link.

In some examples, at 540, the client application 502 may store the transaction link. For example, the client application 502 may store the transaction link, a date associated with generation of the transaction link, or both in a database. In some examples, the client application 502 may display the database to the user.

In some examples, at 545, the client application may deactivate the transaction link such that selection of the transaction link may not initiate the blockchain transaction. For example, the client application 502 may deactivate the transaction link in response to a user input including a request to deactivate the transaction link.

FIG. 6 shows an example of a process flow 600 that supports generating transaction links for initiating blockchain transactions in accordance with aspects of the present disclosure. The process flow 600 may implement or may be implemented by aspects of the computing environment 100, the computing environment 200, the GUI diagram 300, the GUI diagram 400, or the process flow 500. For example, the process flow 600 may be implemented by a client application 602 and a blockchain address application 603, which may be implemented by a user device 140 as described with reference to FIG. 1.

In the following description of the process flow 600, the operations between the client application 602 and the blockchain address application 603 may occur in a different order than the example order shown and, in some examples, may be performed by one or more different devices other than those shown as examples. Some operations also may be omitted from the process flow 600, and other operations may be added to the process flow 600. Further, although some operations or signaling may be shown to occur at different times for discussion purposes, these operations may actually occur at the same time. Although the blockchain address application 603 and the client application 602 are illustrated herein as separate applications, the blockchain address application 603 and the client application 602 may be a same application.

At 605, the client application 602 may receive, from a user, a first user input selecting a transaction link (e.g., a transaction link generated as described with reference to FIG. 5). The transaction link may encode data associated with the blockchain transaction and a signature associated with generation of the transaction link. The data associated with the blockchain transaction may include a destination address (e.g., a destination address associated with a smart contract, a first blockchain address of the blockchain address application 503, or a blockchain address associated with another entity), an ID of the smart contract, an amount of crypto token to transfer via the blockchain transaction, a chain ID, and/or a network ID. In some examples, the destination address may be different form a private key associated with the signature.

The transaction link may be configured to cause a broadcast of one or more messages to cause transfer of the amount of crypto token to the destination address (e.g., configured to call the function of the smart contract to execute the blockchain transaction). In some examples, the transaction link may be a shortened link including a randomized value associated with the data and the signature. The shortened link may also be configured to cause a broadcast of one or more messages to cause transfer of the amount of crypto token to the destination address.

At 610, the client application 602 may direct the user to the blockchain address application 603 (e.g., in response to the first user input). The blockchain address application 603 may be a smart wallet that performs cryptographic operations using a passkey including a string of characters stored on a user device. In some examples (e.g., if the user is not associated with a blockchain address such as a smart wallet associated with the blockchain address application 603), the client application 602 or the blockchain address application 603 may display a first prompt for the user to generate a blockchain address for the blockchain address application 603 and a second prompt for the user to authorize a transfer of the amount of crypto token to the blockchain address. The user may accordingly provide a user input that authorizes the transfer of the amount of crypto token.

At 615, the blockchain address application 603 may receive a user input (e.g., a signature) that initiates the blockchain transaction. For example, the signature may authorize the blockchain address application 603 to broadcast the one or more messages.

At 620, the blockchain address application 603 may broadcast the one or more messages (e.g., in response to receiving the signature). The blockchain address application 603 may accordingly cause the transfer of the amount of token to the destination address in accordance with the data encoded in the transaction link.

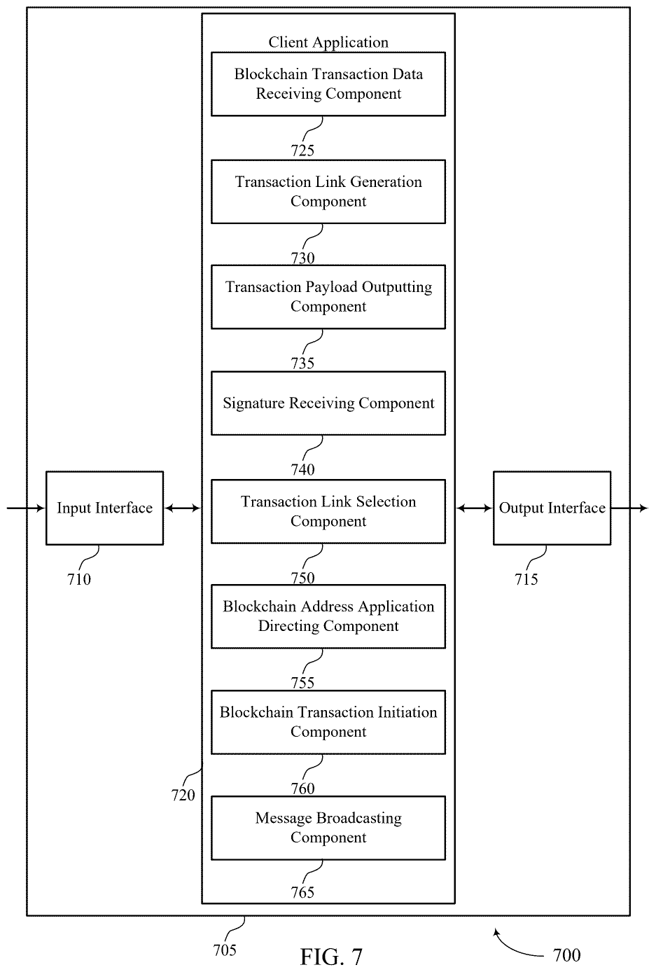

FIG. 7 shows a block diagram 700 of a device 705 that supports generating transaction links for initiating blockchain transactions in accordance with aspects of the present disclosure. The device 705 may include an input interface 710, an output interface 715, and a client application 720. The device 705, or one or more components of the device 705 (e.g., the input interface 710, the output interface 715, the client application 720), may include at least one processor, which may be coupled with at least one memory, to support the described techniques. Each of these components may be in communication with one another (e.g., via one or more buses).

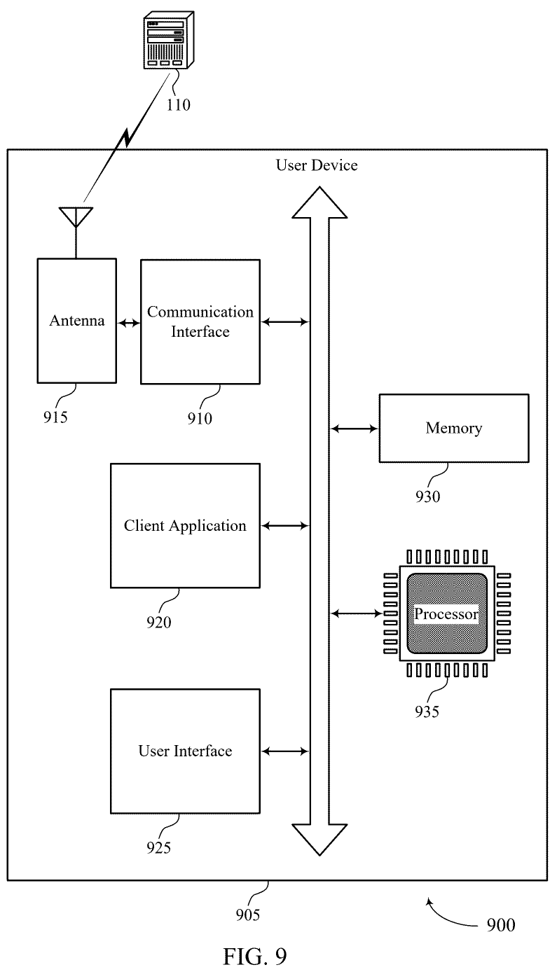

The input interface 710 may manage input signaling for the user device 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the user device 705 for processing. For example, the input interface 710 may transmit such corresponding signaling to the client application 720 to support generating transaction links for initiating blockchain transactions. In some cases, the input interface 710 may be a component of a communication interface 910 as described with reference to FIG. 9.

The output interface 715 may manage output signaling for the device 705. For example, the output interface 715 may receive signaling from other components of the device 705, such as the client application 720, and may transmit such output signaling corresponding to (e.g., representative of or otherwise based on) such signaling to other systems or devices. In some cases, the output interface 615 may be a component of a user interface 925 as described with reference to FIG. 9.

For example, the client application 720 may include a blockchain transaction data receiving component 725, a transaction link generation component 730, a transaction payload outputting component 735, a signature receiving component 740, a transaction link selection component 750, a blockchain address application directing component 755, a blockchain transaction initiation component 760, a message broadcasting component 765, or any combination thereof. In some examples, the client application 720, or various components thereof, may be configured to perform various operations (e.g., receiving, monitoring, transmitting) using or otherwise in cooperation with the input interface 710, the output interface 715, or both. For example, the client application 720 may receive information from the input interface 710, send information to the output interface 715, or be integrated in combination with the input interface 710, the output interface 715, or both to receive information, transmit information, or perform various other operations as described herein.

The client application 720 may support digital token management in accordance with examples as disclosed herein. The blockchain transaction data receiving component 725 may be configured as or otherwise support a means for receiving, via one or more fields of a client application, data associated with a blockchain transaction, the data comprising at least a destination address. The transaction link generation component 730 may be configured as or otherwise support a means for receiving, at the client application, a user input to generate a transaction link associated with the blockchain transaction. The transaction payload outputting component 735 may be configured as or otherwise support a means for outputting, by the client application and to a blockchain address application after receiving the user input, a transaction payload for signature by the blockchain address application, the transaction payload comprising the data associated with the blockchain transaction. The signature receiving component 740 may be configured as or otherwise support a means for receiving, from the blockchain address application, a signature associated with signing the transaction payload by a private key of the blockchain address application. The transaction link generation component 730 may be configured as or otherwise support a means for displaying an indication of the transaction link that encodes the data associated with the blockchain transaction and the signature.

Additionally, or alternatively, the client application 720 may support digital token management in accordance with examples as disclosed herein. The transaction link selection component 750 may be configured as or otherwise support a means for receiving, from a user at a client application, a first user input selecting a transaction link that encodes data associated with a blockchain transaction and a signature associated with generating the transaction link, the data comprising at least a destination address. The blockchain address application directing component 755 may be configured as or otherwise support a means for directing the user to a blockchain address application after receiving the first user input selecting the transaction link. The blockchain transaction initiation component 760 may be configured as or otherwise support a means for receiving a second user input to initiate the blockchain transaction, wherein the second user input comprises a signature that authorizes the blockchain address application to broadcast one or more messages. The message broadcasting component 765 may be configured as or otherwise support a means for broadcasting the one or more messages in response to receiving the second user input, wherein the one or more messages are configured to execute the blockchain transaction in accordance with the data encoded in the transaction link.

Additionally, or alternatively, the client application 720 may support digital token management in accordance with examples as disclosed herein. The 745 may be configured as or otherwise support a means for one or more memories storing processor-executable code. The 745 may be configured as or otherwise support a means for one or more processors coupling with the one or more memories and individually or collectively operable to execute the code to cause the apparatus to. The 745 may be configured as or otherwise support a means for receiving, from a user at a client application, a first user input selecting a transaction link, wherein the transaction link comprises. The 745 may be configured as or otherwise support a means for encoding data associated with a blockchain transaction. The 745 may be configured as or otherwise support a means for a signature associating with generation of the transaction link, wherein the signature is associated with signing a transaction payload by a private key. The 745 may be configured as or otherwise support a means for directing the user to a blockchain address application in response to receiving the first user input selecting the transaction link. The 745 may be configured as or otherwise support a means for receiving a second user input to initiate the blockchain transaction, wherein the second user input comprises a signature that authorizes the blockchain address application to broadcast one or more messages. The 745 may be configured as or otherwise support a means for broadcasting the one or more messages in response to receiving the second user input, wherein the one or more messages are configured to execute the blockchain transaction in accordance with the data encoded in the transaction link.

Additionally, or alternatively, the client application 720 may support digital token management in accordance with examples as disclosed herein. The 745 may be configured as or otherwise support a means for receiving, from a user at a client application, a first user input selecting a transaction link, wherein the transaction link encodes data associated with a blockchain transaction and a signature associated with generating the transaction link, wherein the data associated with the blockchain transaction comprises a destination address. The 745 may be configured as or otherwise support a means for directing the user to a blockchain address application after receiving the first user input selecting the transaction link. The 745 may be configured as or otherwise support a means for receiving a second user input to initiate the blockchain transaction, wherein the second user input comprises a signature that authorizes the blockchain address application to broadcast one or more messages. The 745 may be configured as or otherwise support a means for broadcasting the one or more messages in response to receiving the second user input, wherein the one or more messages are configured to execute the blockchain transaction in accordance with the data encoded in the transaction link.

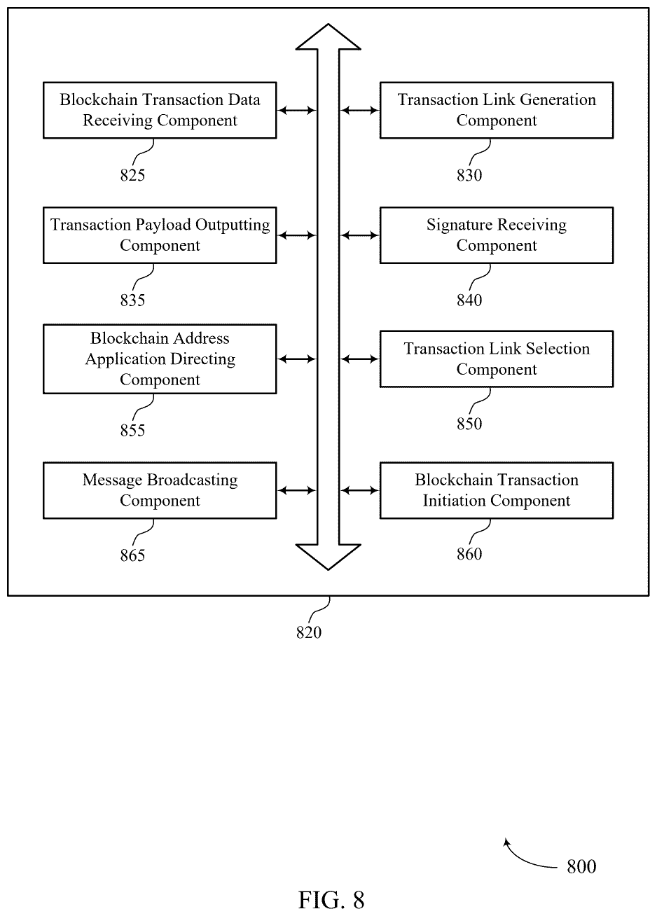

FIG. 8 shows a block diagram 800 of a client application 820 that supports generating transaction links for initiating blockchain transactions in accordance with aspects of the present disclosure. The client application 820 may be an example of aspects of a client application or a client application 720, or both, as described herein. The client application 820, or various components thereof, may be an example of means for performing various aspects of generating transaction links for initiating blockchain transactions as described herein. For example, the client application 820 may include a blockchain transaction data receiving component 825, a transaction link generation component 830, a transaction payload outputting component 835, a signature receiving component 840, a transaction link selection component 850, a blockchain address application directing component 855, a blockchain transaction initiation component 860, a message broadcasting component 865, or any combination thereof. Each of these components, or components of subcomponents thereof (e.g., one or more processors, one or more memories), may communicate, directly or indirectly, with one another (e.g., via one or more buses).

The client application 820 may support digital token management in accordance with examples as disclosed herein. The blockchain transaction data receiving component 825 may be configured as or otherwise support a means for receiving, via one or more fields of a client application, data associated with a blockchain transaction, the data comprising at least a destination address. The transaction link generation component 830 may be configured as or otherwise support a means for receiving, at the client application, a user input to generate a transaction link associated with the blockchain transaction. The transaction payload outputting component 835 may be configured as or otherwise support a means for outputting, by the client application and to a blockchain address application after receiving the user input, a transaction payload for signature by the blockchain address application, the transaction payload comprising the data associated with the blockchain transaction. The signature receiving component 840 may be configured as or otherwise support a means for receiving, from the blockchain address application, a signature associated with signing the transaction payload by a private key of the blockchain address application. In some examples, the transaction link generation component 830 may be configured as or otherwise support a means for displaying an indication of the transaction link that encodes the data associated with the blockchain transaction and the signature.

In some examples, the data associated with the blockchain transaction comprises an amount of a crypto token to transfer via the blockchain transaction, a chain identifier associated with the blockchain transaction, or both.

In some examples, the data associated with the blockchain transaction comprises the destination address associated with a smart contract and an identifier of a function of the smart contract.

In some examples, the signature receiving component 840 may be configured as or otherwise support a means for receiving a second user input indicative of a blockchain address of the blockchain address application that is to sign the transaction payload, wherein the transaction payload is output to the blockchain address application based at least in part on the second user input.

In some examples, displaying the indication of the transaction link comprises displaying, via the client application, a user interface including one or more indications of the data associated with the blockchain transaction, a user interface component configured for copying the transaction link, a first user interface component configured for shortening the transaction link, a second user interface component for viewing the transaction link, or a combination thereof.

In some examples, the signature receiving component 840 may be configured as or otherwise support a means for validating that the signature corresponds to the blockchain address application and that the destination address is not listed on a blacklist of blockchain addresses, wherein the transaction link is displayed after the validating.

In some examples, the transaction link generation component 830 may be configured as or otherwise support a means for storing the transaction link, a date associated with generation of the transaction link, or both in a database.

In some examples, the transaction link is configured to cause a transfer of an amount of crypto token from a smart wallet associated with a second user to the destination address in response to selection by the second user of the transaction link.

In some examples, the destination address comprises a first blockchain address of the blockchain address application or a second blockchain address associated with another entity.

In some examples, the transaction link generation component 830 may be configured as or otherwise support a means for receiving a second user input that comprises a request to deactivate the transaction link. In some examples, the transaction link generation component 830 may be configured as or otherwise support a means for deactivating the transaction link in response to the request.

In some examples, the transaction link generation component 830 may be configured as or otherwise support a means for generating a shortened transaction link based at least in part on the transaction link, wherein the shortened transaction link comprises a randomized value associated with the data and the signature, and wherein the shortened transaction link is configured to initiate broadcast of one or more messages. In some examples, the blockchain address application is different from the client application.

Additionally, or alternatively, the client application 820 may support digital token management in accordance with examples as disclosed herein. The transaction link selection component 850 may be configured as or otherwise support a means for receiving, from a user at a client application, a first user input selecting a transaction link that encodes data associated with a blockchain transaction and a signature associated with generating the transaction link, the data comprising at least a destination address. The blockchain address application directing component 855 may be configured as or otherwise support a means for directing the user to a blockchain address application after receiving the first user input selecting the transaction link. The blockchain transaction initiation component 860 may be configured as or otherwise support a means for receiving a second user input to initiate the blockchain transaction, wherein the second user input comprises a signature that authorizes the blockchain address application to broadcast one or more messages. The message broadcasting component 865 may be configured as or otherwise support a means for broadcasting the one or more messages in response to receiving the second user input, wherein the one or more messages are configured to execute the blockchain transaction in accordance with the data encoded in the transaction link.

In some examples, to support directing the user to the blockchain address application, the blockchain address application directing component 855 may be configured as or otherwise support a means for displaying a first prompt for the user to generate a blockchain address for the blockchain address application. In some examples, to support directing the user to the blockchain address application, the blockchain address application directing component 855 may be configured as or otherwise support a means for displaying a second prompt for the user to authorize a transfer of an amount of a crypto token to the blockchain address. In some examples, to support directing the user to the blockchain address application, the blockchain address application directing component 855 may be configured as or otherwise support a means for receiving a third user input that authorizes the transfer of the amount of crypto token to the blockchain address.

In some examples, the transaction link comprises a shortened transaction link. In some examples, the shortened transaction link comprises a randomized value associated with the data and the signature. In some examples, the shortened transaction link is configured to initiate the broadcasting of the one or more messages.

In some examples, the data associated with the blockchain transaction comprises an amount of a crypto token to transfer to the destination address via the blockchain transaction, a chain identifier associated with the blockchain transaction, or both.

In some examples, the data associated with the blockchain transaction comprises the destination address associated with a smart contract and an identifier of a function of the smart contract. In some examples, the one or more messages are configured to call the function of the smart contract to execute the blockchain transaction.

In some examples, the data associated with the blockchain transaction comprises the destination address different from a private key associated with the signature. In some examples, the one or more messages are configured to execute the blockchain transaction to cause a transfer of a crypto token to the destination address.

In some examples, the blockchain address application comprises a smart wallet that performs cryptographic operations using a passkey comprising a string of characters stored on a user device.

In some examples, the blockchain address application is different from the client application.

Additionally, or alternatively, the client application 820 may support digital token management in accordance with examples as disclosed herein. In some examples, the 845 may be configured as or otherwise support a means for one or more memories storing processor-executable code. In some examples, the 845 may be configured as or otherwise support a means for one or more processors coupling with the one or more memories and individually or collectively operable to execute the code to cause the apparatus to. In some examples, the 845 may be configured as or otherwise support a means for receiving, from a user at a client application, a first user input selecting a transaction link, wherein the transaction link comprises. In some examples, the 845 may be configured as or otherwise support a means for encoding data associated with a blockchain transaction. In some examples, the 845 may be configured as or otherwise support a means for a signature associating with generation of the transaction link, wherein the signature is associated with signing a transaction payload by a private key. In some examples, the 845 may be configured as or otherwise support a means for directing the user to a blockchain address application in response to receiving the first user input selecting the transaction link. In some examples, the 845 may be configured as or otherwise support a means for receiving a second user input to initiate the blockchain transaction, wherein the second user input comprises a signature that authorizes the blockchain address application to broadcast one or more messages. In some examples, the 845 may be configured as or otherwise support a means for broadcasting the one or more messages in response to receiving the second user input, wherein the one or more messages are configured to execute the blockchain transaction in accordance with the data encoded in the transaction link.

Additionally, or alternatively, the client application 820 may support digital token management in accordance with examples as disclosed herein. In some examples, the 845 may be configured as or otherwise support a means for receiving, from a user at a client application, a first user input selecting a transaction link, wherein the transaction link encodes data associated with a blockchain transaction and a signature associated with generating the transaction link, wherein the data associated with the blockchain transaction comprises a destination address. In some examples, the 845 may be configured as or otherwise support a means for directing the user to a blockchain address application after receiving the first user input selecting the transaction link. In some examples, the 845 may be configured as or otherwise support a means for receiving a second user input to initiate the blockchain transaction, wherein the second user input comprises a signature that authorizes the blockchain address application to broadcast one or more messages. In some examples, the 845 may be configured as or otherwise support a means for broadcasting the one or more messages in response to receiving the second user input, wherein the one or more messages are configured to execute the blockchain transaction in accordance with the data encoded in the transaction link.

FIG. 9 shows a diagram of a system 900 including a device 905 that supports generating transaction links for initiating blockchain transactions in accordance with aspects of the present disclosure. The device 905 may be an example of or include components of a device 705 as described herein. The device 905 may include components for bi-directional voice and data communications including components for transmitting and receiving communications, such as a client application 920, a communication interface 910, one or more antennas 915, a user interface 925, at least one memory 930, and at least one processor 935. Each of these components may communicate, directly or indirectly, with one another (e.g., via one or more buses, communications links, communications interfaces, or any combination thereof).

The communication interface 910 may manage input and output signals for the device 905 via the antenna 915. For example, the communication interface 910 may enable the user device 905 to exchange information (e.g., input information, output information, or both) with other systems or devices, such as custodial token platform 110 (e.g., supported by one or more servers), via one or more wired or wireless communication links. The communication interface 910 may also utilize or interact with antenna 915 to support communication with other systems or devices. In some cases, the communication interface 910 may represent a physical connection or port to an external peripheral, such as a hardware wallet device. In some cases, the communication interface 910 may utilize an operating system such as iOS®, ANDROID®, MS-DOS®, MS-WINDOWS®, OS/2®, UNIX®, LINUX®, or another known operating system. The communication interface 910 may be implemented as part of the processor 935.

In some cases, the device 905 may include a single antenna 915. However, in some other cases, the device 905 may have more than one antenna 915, which may be capable of concurrently transmitting or receiving multiple wireless transmissions. The communication interface 910 may communicate bi-directionally, via the one or more antennas 915, wired, or wireless links as described herein. For example, the communication interface 910 may represent a wireless transceiver and may communicate bi-directionally with another wireless transceiver. The communication interface 910 may also include a modem to modulate the packets, to provide the modulated packets to one or more antennas 915 for transmission, and to demodulate packets received from the one or more antennas 915.

The user interface 925 may represent a keyboard, a mouse, a touchscreen, a microphone, or a similar device or component. In some cases, a user may interact with the user interface 925. In other cases, the user interface 925 may operate automatically without user interaction. The user interface 925 may display or output information such as information received from other systems or devices or information to be transmitted to other systems or devices.

The memory 930 may include RAM and ROM. The memory 930 may store computer-readable, computer-executable software including instructions that, when executed, cause at least one processor 935 to perform various functions described herein. In some cases, the memory 930 may contain, among other things, a BIOS which may control basic hardware or software operation such as the interaction with peripheral components or devices. The memory 930 may be an example of a single memory or multiple memories. For example, the user device 905 may include one or more memories 930.

The processor 935 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 935 may be configured to operate a memory array using a memory controller. In other cases, a memory controller may be integrated into the processor 935. The processor 935 may be configured to execute computer-readable instructions stored in at least one memory 930 to perform various functions (e.g., functions or tasks supporting a method and system for generating transaction links for initiating blockchain transactions). Though a single processor 935 is depicted in the example of FIG. 9, it is to be understood that the user device 905 may include any quantity of one or more of processors 935 and that a group of processors 935 may collectively perform one or more functions ascribed herein to a processor, such as the processor 935. The processor 935 may be an example of a single processor or multiple processors. For example, the device 905 may include one or more processors 935.

The client application 920 may support digital token management in accordance with examples as disclosed herein. For example, the client application 920 may be configured as or otherwise support a means for receiving, via one or more fields of a client application, data associated with a blockchain transaction, the data comprising at least a destination address. The client application 920 may be configured as or otherwise support a means for receiving, at the client application, a user input to generate a transaction link associated with the blockchain transaction. The client application 920 may be configured as or otherwise support a means for outputting, by the client application and to a blockchain address application after receiving the user input, a transaction payload for signature by the blockchain address application, the transaction payload comprising the data associated with the blockchain transaction. The client application 920 may be configured as or otherwise support a means for receiving, from the blockchain address application, a signature associated with signing the transaction payload by a private key of the blockchain address application. The client application 920 may be configured as or otherwise support a means for displaying an indication of the transaction link that encodes the data associated with the blockchain transaction and the signature.

Additionally, or alternatively, the client application 920 may support digital token management in accordance with examples as disclosed herein. For example, the client application 920 may be configured as or otherwise support a means for one or more memories storing processor-executable code. The client application 920 may be configured as or otherwise support a means for one or more processors coupling with the one or more memories and individually or collectively operable to execute the code to cause the apparatus to. The client application 920 may be configured as or otherwise support a means for receiving, via one or more fields of a client application, data associated with a blockchain transaction. The client application 920 may be configured as or otherwise support a means for receiving, at the client application, a user input to generate a transaction link associated with the blockchain transaction. The client application 920 may be configured as or otherwise support a means for output, by the client application and to a blockchain address application, a transaction payload for signature by the blockchain address application, the transaction payload comprising the data associated with the blockchain transaction. The client application 920 may be configured as or otherwise support a means for receiving, from the blockchain address application, a signature associated with signing the transaction payload by a private key of the blockchain address application. The client application 920 may be configured as or otherwise support a means for display, via the client application, a user interface including one or more indications of the data associated with the blockchain transaction, a first user interface component configured for copying the transaction link, a second user interface component configured for shortening the transaction link, a user interface component for viewing the transaction link, or a combination thereof.

Additionally, or alternatively, the client application 920 may support digital token management in accordance with examples as disclosed herein. For example, the client application 920 may be configured as or otherwise support a means for receiving, at one or more fields of a client application, data associated with a blockchain transaction, the data comprising at least a destination address. The client application 920 may be configured as or otherwise support a means for receiving, at the client application and from a user, a request to generate a transaction link associated with the blockchain transaction. The client application 920 may be configured as or otherwise support a means for output, by the client application and to a blockchain address application after receiving the request, a transaction payload for signature by the blockchain address application, the transaction payload comprising the data associated with the blockchain transaction. The client application 920 may be configured as or otherwise support a means for receiving, from the blockchain address application, a signature associated with signing the transaction payload by a private key of the blockchain address application. The client application 920 may be configured as or otherwise support a means for encoding the data associated with the blockchain transaction and the signature in the transaction link. The client application 920 may be configured as or otherwise support a means for display, to the user via a graphical user interface, an indication of the transaction link, wherein the transaction link comprising the encoded data and the encoded signature.

Additionally, or alternatively, the client application 920 may support digital token management in accordance with examples as disclosed herein. For example, the client application 920 may be configured as or otherwise support a means for receiving, from a user at a client application, a first user input selecting a transaction link that encodes data associated with a blockchain transaction and a signature associated with generating the transaction link, the data comprising at least a destination address. The client application 920 may be configured as or otherwise support a means for directing the user to a blockchain address application after receiving the first user input selecting the transaction link. The client application 920 may be configured as or otherwise support a means for receiving a second user input to initiate the blockchain transaction, wherein the second user input comprises a signature that authorizes the blockchain address application to broadcast one or more messages. The client application 920 may be configured as or otherwise support a means for broadcasting the one or more messages in response to receiving the second user input, wherein the one or more messages are configured to execute the blockchain transaction in accordance with the data encoded in the transaction link.

Additionally, or alternatively, the client application 920 may support digital token management in accordance with examples as disclosed herein. For example, the client application 920 may be configured as or otherwise support a means for one or more memories storing processor-executable code. The client application 920 may be configured as or otherwise support a means for one or more processors coupling with the one or more memories and individually or collectively operable to execute the code to cause the apparatus to. The client application 920 may be configured as or otherwise support a means for receiving, from a user at a client application, a first user input selecting a transaction link, wherein the transaction link comprises. The client application 920 may be configured as or otherwise support a means for encoding data associated with a blockchain transaction. The client application 920 may be configured as or otherwise support a means for a signature associating with generation of the transaction link, wherein the signature is associated with signing a transaction payload by a private key. The client application 920 may be configured as or otherwise support a means for directing the user to a blockchain address application in response to receiving the first user input selecting the transaction link. The client application 920 may be configured as or otherwise support a means for receiving a second user input to initiate the blockchain transaction, wherein the second user input comprises a signature that authorizes the blockchain address application to broadcast one or more messages. The client application 920 may be configured as or otherwise support a means for broadcasting the one or more messages in response to receiving the second user input, wherein the one or more messages are configured to execute the blockchain transaction in accordance with the data encoded in the transaction link.

Additionally, or alternatively, the client application 920 may support digital token management in accordance with examples as disclosed herein. For example, the client application 920 may be configured as or otherwise support a means for receiving, from a user at a client application, a first user input selecting a transaction link, wherein the transaction link encodes data associated with a blockchain transaction and a signature associated with generating the transaction link, wherein the data associated with the blockchain transaction comprises a destination address. The client application 920 may be configured as or otherwise support a means for directing the user to a blockchain address application after receiving the first user input selecting the transaction link. The client application 920 may be configured as or otherwise support a means for receiving a second user input to initiate the blockchain transaction, wherein the second user input comprises a signature that authorizes the blockchain address application to broadcast one or more messages. The client application 920 may be configured as or otherwise support a means for broadcasting the one or more messages in response to receiving the second user input, wherein the one or more messages are configured to execute the blockchain transaction in accordance with the data encoded in the transaction link.

By including or configuring the client application 920 in accordance with examples as described herein, the device 905 may support techniques for generating transaction links, which may result in improved user experience related to reduced processing as a result of enabling recurring transactions.

The client application 920 may include an application (e.g., “app”), program, software, extension, or other component which is configured to facilitate communications with a custodial token platform 110 on a server, one or more nodes of a blockchain network 105, other user devices 905, and other devices or systems. For example, the client application 920 may be an application executable on the user device 905, and the client application 920 may be configured to receive data from a custodial token platform 110, transmit data to the custodial token platform 110, process such data, and cause presentation of such data to a user via a user interface 925. The client application 920 may be an example of a wallet application, a wallet device, or both, and may be associated with a wallet address and may access or use a private key to sign messages to facilitate transfer of crypto tokens, messages, transactions, or the like via a blockchain distributed data store.

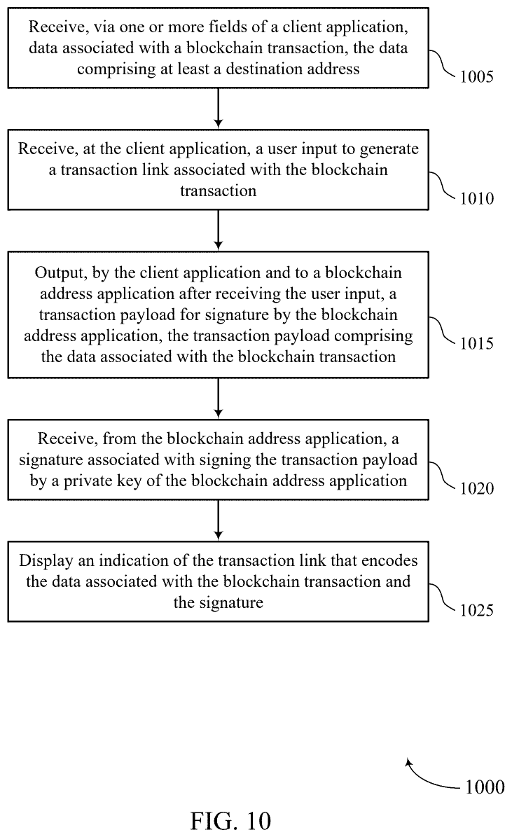

FIG. 10 shows a flowchart illustrating a method 1000 that supports generating transaction links for initiating blockchain transactions in accordance with aspects of the present disclosure. The operations of the method 1000 may be implemented by a user device or its components as described herein. For example, the operations of the method 1000 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1005, the method may include receiving, via one or more fields of a client application, data associated with a blockchain transaction, the data comprising at least a destination address. The operations of 1005 may be performed in accordance with examples as disclosed herein. In some examples, aspects of the operations of 1005 may be performed by a blockchain transaction data receiving component 825 as described with reference to FIG. 8.

At 1010, the method may include receiving, at the client application, a user input to generate a transaction link associated with the blockchain transaction. The operations of 1010 may be performed in accordance with examples as disclosed herein. In some examples, aspects of the operations of 1010 may be performed by a transaction link generation component 830 as described with reference to FIG. 8.

At 1015, the method may include outputting, by the client application and to a blockchain address application after receiving the user input, a transaction payload for signature by the blockchain address application, the transaction payload comprising the data associated with the blockchain transaction. The operations of 1015 may be performed in accordance with examples as disclosed herein. In some examples, aspects of the operations of 1015 may be performed by a transaction payload outputting component 835 as described with reference to FIG. 8.

At 1020, the method may include receiving, from the blockchain address application, a signature associated with signing the transaction payload by a private key of the blockchain address application. The operations of 1020 may be performed in accordance with examples as disclosed herein. In some examples, aspects of the operations of 1020 may be performed by a signature receiving component 840 as described with reference to FIG. 8.

At 1025, the method may include displaying an indication of the transaction link that encodes the data associated with the blockchain transaction and the signature. The operations of 1025 may be performed in accordance with examples as disclosed herein. In some examples, aspects of the operations of 1025 may be performed by a transaction link generation component 830 as described with reference to FIG. 8.

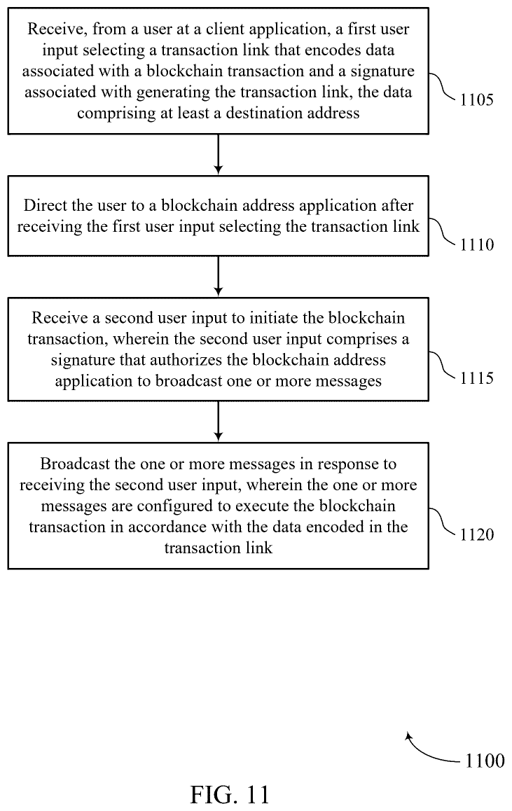

FIG. 11 shows a flowchart illustrating a method 1100 that supports generating transaction links for initiating blockchain transactions in accordance with aspects of the present disclosure. The operations of the method 1100 may be implemented by a user device or its components as described herein. For example, the operations of the method 1100 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1105, the method may include receiving, from a user at a client application, a first user input selecting a transaction link that encodes data associated with a blockchain transaction and a signature associated with generating the transaction link, the data comprising at least a destination address. The operations of 1105 may be performed in accordance with examples as disclosed herein. In some examples, aspects of the operations of 1105 may be performed by a transaction link selection component 850 as described with reference to FIG. 8.

At 1110, the method may include directing the user to a blockchain address application after receiving the first user input selecting the transaction link. The operations of 1110 may be performed in accordance with examples as disclosed herein. In some examples, aspects of the operations of 1110 may be performed by a blockchain address application directing component 855 as described with reference to FIG. 8.

At 1115, the method may include receiving a second user input to initiate the blockchain transaction, wherein the second user input comprises a signature that authorizes the blockchain address application to broadcast one or more messages. The operations of 1115 may be performed in accordance with examples as disclosed herein. In some examples, aspects of the operations of 1115 may be performed by a blockchain transaction initiation component 860 as described with reference to FIG. 8.

At 1120, the method may include broadcasting the one or more messages in response to receiving the second user input, wherein the one or more messages are configured to execute the blockchain transaction in accordance with the data encoded in the transaction link. The operations of 1120 may be performed in accordance with examples as disclosed herein. In some examples, aspects of the operations of 1120 may be performed by a message broadcasting component 865 as described with reference to FIG. 8.

A method for digital token management by an apparatus is described. The method may include receiving, via one or more fields of a client application, data associated with a blockchain transaction, the data comprising at least a destination address, receiving, at the client application, a user input to generate a transaction link associated with the blockchain transaction, outputting, by the client application and to a blockchain address application after receiving the user input, a transaction payload for signature by the blockchain address application, the transaction payload comprising the data associated with the blockchain transaction, receiving, from the blockchain address application, a signature associated with signing the transaction payload by a private key of the blockchain address application, and displaying an indication of the transaction link that encodes the data associated with the blockchain transaction and the signature.

An apparatus for digital token management is described. The apparatus may include one or more memories storing processor executable code, and one or more processors coupled with the one or more memories. The one or more processors may individually or collectively be operable to execute the code to cause the apparatus to receive, via one or more fields of a client application, data associated with a blockchain transaction, the data comprising at least a destination address, receive, at the client application, a user input to generate a transaction link associated with the blockchain transaction, output, by the client application and to a blockchain address application after receiving the user input, a transaction payload for signature by the blockchain address application, the transaction payload comprising the data associated with the blockchain transaction, receive, from the blockchain address application, a signature associated with signing the transaction payload by a private key of the blockchain address application, and display an indication of the transaction link that encodes the data associated with the blockchain transaction and the signature.

Another apparatus for digital token management is described. The apparatus may include means for receiving, via one or more fields of a client application, data associated with a blockchain transaction, the data comprising at least a destination address, means for receiving, at the client application, a user input to generate a transaction link associated with the blockchain transaction, means for outputting, by the client application and to a blockchain address application after receiving the user input, a transaction payload for signature by the blockchain address application, the transaction payload comprising the data associated with the blockchain transaction, means for receiving, from the blockchain address application, a signature associated with signing the transaction payload by a private key of the blockchain address application, and means for displaying an indication of the transaction link that encodes the data associated with the blockchain transaction and the signature.

A non-transitory computer-readable medium storing code for digital token management is described. The code may include instructions executable by one or more processors to receive, via one or more fields of a client application, data associated with a blockchain transaction, the data comprising at least a destination address, receive, at the client application, a user input to generate a transaction link associated with the blockchain transaction, output, by the client application and to a blockchain address application after receiving the user input, a transaction payload for signature by the blockchain address application, the transaction payload comprising the data associated with the blockchain transaction, receive, from the blockchain address application, a signature associated with signing the transaction payload by a private key of the blockchain address application, and display an indication of the transaction link that encodes the data associated with the blockchain transaction and the signature.

In some examples of the method, apparatus, and non-transitory computer-readable medium described herein, the data associated with the blockchain transaction comprises an amount of a crypto token to transfer via the blockchain transaction, a chain identifier associated with the blockchain transaction, or both.

In some examples of the method, apparatus, and non-transitory computer-readable medium described herein, the data associated with the blockchain transaction comprises the destination address associated with a smart contract and an identifier of a function of the smart contract.

Some examples of the method, apparatus, and non-transitory computer-readable medium described herein may further include operations, features, means, or instructions for receiving a second user input indicative of a blockchain address of the blockchain address application that may be to sign the transaction payload, wherein the transaction payload may be output to the blockchain address application based at least in part on the second user input.

Some examples of the method, apparatus, and non-transitory computer-readable medium described herein may further include operations, features, means, or instructions for displaying the indication of the transaction link comprises displaying, via the client application, a user interface including one or more indications of the data associated with the blockchain transaction, a user interface component configured for copying the transaction link, a first user interface component configured for shortening the transaction link, a second user interface component for viewing the transaction link, or a combination thereof.

Some examples of the method, apparatus, and non-transitory computer-readable medium described herein may further include operations, features, means, or instructions for validating that the signature corresponds to the blockchain address application and that the destination address may be not listed on a blacklist of blockchain addresses, wherein the transaction link may be displayed after the validating.

Some examples of the method, apparatus, and non-transitory computer-readable medium described herein may further include operations, features, means, or instructions for storing the transaction link, a date associated with generation of the transaction link, or both in a database.

In some examples of the method, apparatus, and non-transitory computer-readable medium described herein, the transaction link may be configured to cause a transfer of an amount of crypto token from a smart wallet associated with a second user to the destination address in response to selection by the second user of the transaction link.

In some examples of the method, apparatus, and non-transitory computer-readable medium described herein, the destination address comprises a first blockchain address of the blockchain address application or a second blockchain address associated with another entity.

Some examples of the method, apparatus, and non-transitory computer-readable medium described herein may further include operations, features, means, or instructions for receiving a second user input that comprises a request to deactivate the transaction link and deactivating the transaction link in response to the request.

Some examples of the method, apparatus, and non-transitory computer-readable medium described herein may further include operations, features, means, or instructions for generating a shortened transaction link based at least in part on the transaction link, wherein the shortened transaction link comprises a randomized value associated with the data and the signature, and wherein the shortened transaction link may be configured to initiate broadcast of one or more messages.

In some examples of the method, apparatus, and non-transitory computer-readable medium described herein, the blockchain address application may be different from the client application.

A method for digital token management by an apparatus for digital token management is described. The method may include one or more memories storing processor-executable code, one or more processors coupling with the one or more memories and individually or collectively operable to execute the code to cause the apparatus to, receiving, via one or more fields of a client application, data associated with a blockchain transaction, receiving, at the client application, a user input to generate a transaction link associated with the blockchain transaction, output, by the client application and to a blockchain address application, a transaction payload for signature by the blockchain address application, the transaction payload comprising the data associated with the blockchain transaction, receiving, from the blockchain address application, a signature associated with signing the transaction payload by a private key of the blockchain address application, and display, via the client application, a user interface including one or more indications of the data associated with the blockchain transaction, a first user interface component configured for copying the transaction link, a second user interface component configured for shortening the transaction link, a user interface component for viewing the transaction link, or a combination thereof.

An apparatus for digital token management for digital token management is described. The apparatus for digital token management may include one or more memories storing processor executable code, and one or more processors coupled with the one or more memories. The one or more processors may individually or collectively be operable to execute the code to cause the apparatus for digital token management to one or more memories storing processor-executable code, one or more processors coupled with the one or more memories and individually or collectively operable to execute the code to cause the apparatus to, receive, via one or more fields of a client application, data associated with a blockchain transaction, receive, at the client application, a user input to generate a transaction link associated with the blockchain transaction, output, by the client application and to a blockchain address application, a transaction payload for signature by the blockchain address application, the transaction payload comprising the data associated with the blockchain transaction, receive, from the blockchain address application, a signature associated with signing the transaction payload by a private key of the blockchain address application, and display, via the client application, a user interface including one or more indications of the data associated with the blockchain transaction, a first user interface component configured for copying the transaction link, a second user interface component configured for shortening the transaction link, a user interface component for viewing the transaction link, or a combination thereof.

Another apparatus for digital token management for digital token management is described. The apparatus for digital token management may include means for one or more memories storing processor-executable code, means for one or more processors coupling with the one or more memories and individually or collectively operable to execute the code to cause the apparatus to, means for receiving, via one or more fields of a client application, data associated with a blockchain transaction, means for receiving, at the client application, a user input to generate a transaction link associated with the blockchain transaction, means for output, by the client application and to a blockchain address application, a transaction payload for signature by the blockchain address application, the transaction payload comprising the data associated with the blockchain transaction, means for receiving, from the blockchain address application, a signature associated with signing the transaction payload by a private key of the blockchain address application, and means for display, via the client application, a user interface including one or more indications of the data associated with the blockchain transaction, a first user interface component configured for copying the transaction link, a second user interface component configured for shortening the transaction link, a user interface component for viewing the transaction link, or a combination thereof.

A non-transitory computer-readable medium storing code for digital token management is described. The code may include instructions executable by one or more processors to one or more memories storing processor-executable code, one or more processors coupled with the one or more memories and individually or collectively operable to execute the code to cause the apparatus to, receive, via one or more fields of a client application, data associated with a blockchain transaction, receive, at the client application, a user input to generate a transaction link associated with the blockchain transaction, output, by the client application and to a blockchain address application, a transaction payload for signature by the blockchain address application, the transaction payload comprising the data associated with the blockchain transaction, receive, from the blockchain address application, a signature associated with signing the transaction payload by a private key of the blockchain address application, and display, via the client application, a user interface including one or more indications of the data associated with the blockchain transaction, a first user interface component configured for copying the transaction link, a second user interface component configured for shortening the transaction link, a user interface component for viewing the transaction link, or a combination thereof.

A method for digital token management by an apparatus is described. The method may include receiving, at one or more fields of a client application, data associated with a blockchain transaction, the data comprising at least a destination address, receiving, at the client application and from a user, a request to generate a transaction link associated with the blockchain transaction, output, by the client application and to a blockchain address application after receiving the request, a transaction payload for signature by the blockchain address application, the transaction payload comprising the data associated with the blockchain transaction, receiving, from the blockchain address application, a signature associated with signing the transaction payload by a private key of the blockchain address application, encoding the data associated with the blockchain transaction and the signature in the transaction link, and display, to the user via a graphical user interface, an indication of the transaction link, wherein the transaction link comprising the encoded data and the encoded signature.

An apparatus for digital token management is described. The apparatus may include one or more memories storing processor executable code, and one or more processors coupled with the one or more memories. The one or more processors may individually or collectively be operable to execute the code to cause the apparatus to receive, at one or more fields of a client application, data associated with a blockchain transaction, the data comprising at least a destination address, receive, at the client application and from a user, a request to generate a transaction link associated with the blockchain transaction, output, by the client application and to a blockchain address application after receiving the request, a transaction payload for signature by the blockchain address application, the transaction payload comprising the data associated with the blockchain transaction, receive, from the blockchain address application, a signature associated with signing the transaction payload by a private key of the blockchain address application, encode the data associated with the blockchain transaction and the signature in the transaction link, and display, to the user via a graphical user interface, an indication of the transaction link, wherein the transaction link comprises the encoded data and the encoded signature.

Another apparatus for digital token management is described. The apparatus may include means for receiving, at one or more fields of a client application, data associated with a blockchain transaction, the data comprising at least a destination address, means for receiving, at the client application and from a user, a request to generate a transaction link associated with the blockchain transaction, means for output, by the client application and to a blockchain address application after receiving the request, a transaction payload for signature by the blockchain address application, the transaction payload comprising the data associated with the blockchain transaction, means for receiving, from the blockchain address application, a signature associated with signing the transaction payload by a private key of the blockchain address application, means for encoding the data associated with the blockchain transaction and the signature in the transaction link, and means for display, to the user via a graphical user interface, an indication of the transaction link, wherein the transaction link comprising the encoded data and the encoded signature.

A non-transitory computer-readable medium storing code for digital token management is described. The code may include instructions executable by one or more processors to receive, at one or more fields of a client application, data associated with a blockchain transaction, the data comprising at least a destination address, receive, at the client application and from a user, a request to generate a transaction link associated with the blockchain transaction, output, by the client application and to a blockchain address application after receiving the request, a transaction payload for signature by the blockchain address application, the transaction payload comprising the data associated with the blockchain transaction, receive, from the blockchain address application, a signature associated with signing the transaction payload by a private key of the blockchain address application, encode the data associated with the blockchain transaction and the signature in the transaction link, and display, to the user via a graphical user interface, an indication of the transaction link, wherein the transaction link comprises the encoded data and the encoded signature.

A method for digital token management by an apparatus is described. The method may include receiving, from a user at a client application, a first user input selecting a transaction link that encodes data associated with a blockchain transaction and a signature associated with generating the transaction link, the data comprising at least a destination address, directing the user to a blockchain address application after receiving the first user input selecting the transaction link, receiving a second user input to initiate the blockchain transaction, wherein the second user input comprises a signature that authorizes the blockchain address application to broadcast one or more messages, and broadcasting the one or more messages in response to receiving the second user input, wherein the one or more messages are configured to execute the blockchain transaction in accordance with the data encoded in the transaction link.

An apparatus for digital token management is described. The apparatus may include one or more memories storing processor executable code, and one or more processors coupled with the one or more memories. The one or more processors may individually or collectively be operable to execute the code to cause the apparatus to receive, from a user at a client application, a first user input selecting a transaction link that encodes data associated with a blockchain transaction and a signature associated with generating the transaction link, the data comprising at least a destination address, direct the user to a blockchain address application after receiving the first user input selecting the transaction link, receive a second user input to initiate the blockchain transaction, wherein the second user input comprises a signature that authorizes the blockchain address application to broadcast one or more messages, and broadcast the one or more messages in response to receiving the second user input, wherein the one or more messages are configured to execute the blockchain transaction in accordance with the data encoded in the transaction link.

Another apparatus for digital token management is described. The apparatus may include means for receiving, from a user at a client application, a first user input selecting a transaction link that encodes data associated with a blockchain transaction and a signature associated with generating the transaction link, the data comprising at least a destination address, means for directing the user to a blockchain address application after receiving the first user input selecting the transaction link, means for receiving a second user input to initiate the blockchain transaction, wherein the second user input comprises a signature that authorizes the blockchain address application to broadcast one or more messages, and means for broadcasting the one or more messages in response to receiving the second user input, wherein the one or more messages are configured to execute the blockchain transaction in accordance with the data encoded in the transaction link.

A non-transitory computer-readable medium storing code for digital token management is described. The code may include instructions executable by one or more processors to receive, from a user at a client application, a first user input selecting a transaction link that encodes data associated with a blockchain transaction and a signature associated with generating the transaction link, the data comprising at least a destination address, direct the user to a blockchain address application after receiving the first user input selecting the transaction link, receive a second user input to initiate the blockchain transaction, wherein the second user input comprises a signature that authorizes the blockchain address application to broadcast one or more messages, and broadcast the one or more messages in response to receiving the second user input, wherein the one or more messages are configured to execute the blockchain transaction in accordance with the data encoded in the transaction link.

In some examples of the method, apparatus, and non-transitory computer-readable medium described herein, directing the user to the blockchain address application may include operations, features, means, or instructions for displaying a first prompt for the user to generate a blockchain address for the blockchain address application, displaying a second prompt for the user to authorize a transfer of an amount of a crypto token to the blockchain address, and receiving a third user input that authorizes the transfer of the amount of crypto token to the blockchain address.

In some examples of the method, apparatus, and non-transitory computer-readable medium described herein, the transaction link comprises a shortened transaction link, the shortened transaction link comprises a randomized value associated with the data and the signature, and the shortened transaction link may be configured to initiate the broadcasting of the one or more messages.

In some examples of the method, apparatus, and non-transitory computer-readable medium described herein, the data associated with the blockchain transaction comprises an amount of a crypto token to transfer to the destination address via the blockchain transaction, a chain identifier associated with the blockchain transaction, or both.

In some examples of the method, apparatus, and non-transitory computer-readable medium described herein, the data associated with the blockchain transaction comprises the destination address associated with a smart contract and an identifier of a function of the smart contract and the one or more messages may be configured to call the function of the smart contract to execute the blockchain transaction.

In some examples of the method, apparatus, and non-transitory computer-readable medium described herein, the data associated with the blockchain transaction comprises the destination address different from a private key associated with the signature and the one or more messages may be configured to execute the blockchain transaction to cause a transfer of a crypto token to the destination address.

In some examples of the method, apparatus, and non-transitory computer-readable medium described herein, the blockchain address application comprises a smart wallet that performs cryptographic operations using a passkey comprising a string of characters stored on a user device.

In some examples of the method, apparatus, and non-transitory computer-readable medium described herein, the blockchain address application may be different from the client application.

A method for digital token management by an apparatus for digital token management is described. The method may include one or more memories storing processor-executable code, one or more processors coupling with the one or more memories and individually or collectively operable to execute the code to cause the apparatus to, receiving, from a user at a client application, a first user input selecting a transaction link, wherein the transaction link comprises, encoding data associated with a blockchain transaction, a signature associating with generation of the transaction link, wherein the signature is associated with signing a transaction payload by a private key, directing the user to a blockchain address application in response to receiving the first user input selecting the transaction link, receiving a second user input to initiate the blockchain transaction, wherein the second user input comprises a signature that authorizes the blockchain address application to broadcast one or more messages, and broadcasting the one or more messages in response to receiving the second user input, wherein the one or more messages are configured to execute the blockchain transaction in accordance with the data encoded in the transaction link.

An apparatus for digital token management for digital token management is described. The apparatus for digital token management may include one or more memories storing processor executable code, and one or more processors coupled with the one or more memories. The one or more processors may individually or collectively be operable to execute the code to cause the apparatus for digital token management to one or more memories storing processor-executable code, one or more processors coupled with the one or more memories and individually or collectively operable to execute the code to cause the apparatus to, receive, from a user at a client application, a first user input selecting a transaction link, wherein the transaction link comprises, encoded data associated with a blockchain transaction, a signature associated with generation of the transaction link, wherein the signature is associated with signing a transaction payload by a private key, direct the user to a blockchain address application in response to receiving the first user input selecting the transaction link, receive a second user input to initiate the blockchain transaction, wherein the second user input comprises a signature that authorizes the blockchain address application to broadcast one or more messages, and broadcast the one or more messages in response to receiving the second user input, wherein the one or more messages are configured to execute the blockchain transaction in accordance with the data encoded in the transaction link.

Another apparatus for digital token management for digital token management is described. The apparatus for digital token management may include means for one or more memories storing processor-executable code, means for one or more processors coupling with the one or more memories and individually or collectively operable to execute the code to cause the apparatus to, means for receiving, from a user at a client application, a first user input selecting a transaction link, wherein the transaction link comprises, means for encoding data associated with a blockchain transaction, means for a signature associating with generation of the transaction link, wherein the signature is associated with signing a transaction payload by a private key, means for directing the user to a blockchain address application in response to receiving the first user input selecting the transaction link, means for receiving a second user input to initiate the blockchain transaction, wherein the second user input comprises a signature that authorizes the blockchain address application to broadcast one or more messages, and means for broadcasting the one or more messages in response to receiving the second user input, wherein the one or more messages are configured to execute the blockchain transaction in accordance with the data encoded in the transaction link.

A non-transitory computer-readable medium storing code for digital token management is described. The code may include instructions executable by one or more processors to one or more memories storing processor-executable code, one or more processors coupled with the one or more memories and individually or collectively operable to execute the code to cause the apparatus to, receive, from a user at a client application, a first user input selecting a transaction link, wherein the transaction link comprises, encoded data associated with a blockchain transaction, a signature associated with generation of the transaction link, wherein the signature is associated with signing a transaction payload by a private key, direct the user to a blockchain address application in response to receiving the first user input selecting the transaction link, receive a second user input to initiate the blockchain transaction, wherein the second user input comprises a signature that authorizes the blockchain address application to broadcast one or more messages, and broadcast the one or more messages in response to receiving the second user input, wherein the one or more messages are configured to execute the blockchain transaction in accordance with the data encoded in the transaction link.

A method for digital token management by an apparatus is described. The method may include receiving, from a user at a client application, a first user input selecting a transaction link, wherein the transaction link encodes data associated with a blockchain transaction and a signature associated with generating the transaction link, wherein the data associated with the blockchain transaction comprises a destination address, directing the user to a blockchain address application after receiving the first user input selecting the transaction link, receiving a second user input to initiate the blockchain transaction, wherein the second user input comprises a signature that authorizes the blockchain address application to broadcast one or more messages, and broadcasting the one or more messages in response to receiving the second user input, wherein the one or more messages are configured to execute the blockchain transaction in accordance with the data encoded in the transaction link.

An apparatus for digital token management is described. The apparatus may include one or more memories storing processor executable code, and one or more processors coupled with the one or more memories. The one or more processors may individually or collectively be operable to execute the code to cause the apparatus to receive, from a user at a client application, a first user input selecting a transaction link, wherein the transaction link encodes data associated with a blockchain transaction and a signature associated with generating the transaction link, wherein the data associated with the blockchain transaction comprises a destination address, direct the user to a blockchain address application after receiving the first user input selecting the transaction link, receive a second user input to initiate the blockchain transaction, wherein the second user input comprises a signature that authorizes the blockchain address application to broadcast one or more messages, and broadcast the one or more messages in response to receiving the second user input, wherein the one or more messages are configured to execute the blockchain transaction in accordance with the data encoded in the transaction link.

Another apparatus for digital token management is described. The apparatus may include means for receiving, from a user at a client application, a first user input selecting a transaction link, wherein the transaction link encodes data associated with a blockchain transaction and a signature associated with generating the transaction link, wherein the data associated with the blockchain transaction comprises a destination address, means for directing the user to a blockchain address application after receiving the first user input selecting the transaction link, means for receiving a second user input to initiate the blockchain transaction, wherein the second user input comprises a signature that authorizes the blockchain address application to broadcast one or more messages, and means for broadcasting the one or more messages in response to receiving the second user input, wherein the one or more messages are configured to execute the blockchain transaction in accordance with the data encoded in the transaction link.

A non-transitory computer-readable medium storing code for digital token management is described. The code may include instructions executable by one or more processors to receive, from a user at a client application, a first user input selecting a transaction link, wherein the transaction link encodes data associated with a blockchain transaction and a signature associated with generating the transaction link, wherein the data associated with the blockchain transaction comprises a destination address, direct the user to a blockchain address application after receiving the first user input selecting the transaction link, receive a second user input to initiate the blockchain transaction, wherein the second user input comprises a signature that authorizes the blockchain address application to broadcast one or more messages, and broadcast the one or more messages in response to receiving the second user input, wherein the one or more messages are configured to execute the blockchain transaction in accordance with the data encoded in the transaction link.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for digital token management, comprising:
receiving, via one or more fields of a client application, data associated with a blockchain transaction, the data comprising at least a destination address;
receiving, at the client application, a user input to generate a transaction link associated with the blockchain transaction;
outputting, by the client application and to a blockchain address application after receiving the user input, a transaction payload for signature by the blockchain address application, the transaction payload comprising the data associated with the blockchain transaction;
receiving, from the blockchain address application, a signature associated with signing the transaction payload by a private key of the blockchain address application; and
displaying an indication of the transaction link that encodes the data associated with the blockchain transaction and the signature.

2. The method of claim 1, wherein the data associated with the blockchain transaction comprises an amount of a crypto token to transfer via the blockchain transaction, a chain identifier associated with the blockchain transaction, or both.

3. The method of claim 1, wherein the data associated with the blockchain transaction comprises the destination address associated with a smart contract and an identifier of a function of the smart contract.

4. The method of claim 1, further comprising:
receiving a second user input indicative of a blockchain address of the blockchain address application that is to sign the transaction payload, wherein the transaction payload is output to the blockchain address application based at least in part on the second user input.

5. The method of claim 1, wherein displaying the indication of the transaction link comprises displaying, via the client application, a user interface including one or more indications of the data associated with the blockchain transaction, a first user interface component configured for copying the transaction link, a second user interface component configured for shortening the transaction link, a third user interface component configured for viewing the transaction link, or a combination thereof.

6. The method of claim 1, further comprising:
validating that the signature corresponds to the blockchain address application and that the destination address is not listed on a blacklist of blockchain addresses, wherein the transaction link is displayed after the validating.

7. The method of claim 1, further comprising:
storing the transaction link, a date associated with generation of the transaction link, or both in a database.

8. The method of claim 1, wherein the transaction link is configured to cause a transfer of an amount of crypto token from a smart wallet associated with a second user to the destination address in response to selection by the second user of the transaction link.

9. The method of claim 1, wherein the destination address comprises a first blockchain address of the blockchain address application or a second blockchain address associated with another entity.

10. The method of claim 1, further comprising:
receiving a second user input that comprises a request to deactivate the transaction link; and
deactivating the transaction link in response to the request.

11. The method of claim 1, further comprising:
generating a shortened transaction link based at least in part on the transaction link, wherein the shortened transaction link comprises a randomized value associated with the data associated with the blockchain transaction and the signature, and wherein the shortened transaction link is configured to initiate broadcast of one or more messages.

12. The method of claim 1, wherein the blockchain address application is different from the client application.

13. An apparatus for digital token management, comprising:
one or more memories storing processor-executable code; and
one or more processors coupled with the one or more memories and individually or collectively operable to execute the code to cause the apparatus to:
receive, via one or more fields of a client application, data associated with a blockchain transaction;
receive, at the client application, a user input to generate a transaction link associated with the blockchain transaction;
output, by the client application and to a blockchain address application, a transaction payload for signature by the blockchain address application, the transaction payload comprising the data associated with the blockchain transaction;
receive, from the blockchain address application, a signature associated with signing the transaction payload by a private key of the blockchain address application; and
display, via the client application, a user interface including one or more indications of the data associated with the blockchain transaction, a first user interface component configured for copying the transaction link, a second user interface component configured for shortening the transaction link, a user interface component for viewing the transaction link, or a combination thereof.

14. The apparatus of claim 13, wherein the data associated with the blockchain transaction comprises an amount of a crypto token to transfer via the blockchain transaction, a chain identifier associated with the blockchain transaction, or both.

15. The apparatus of claim 13, wherein the data associated with the blockchain transaction comprises a destination address associated with a smart contract and an identifier of a function of the smart contract.

16. The apparatus of claim 13, wherein the one or more processors are individually or collectively further operatable to execute the code to cause the apparatus to:
receive a second user input indicative of a blockchain address of the blockchain address application that is to sign the transaction payload, wherein the transaction payload is output to the blockchain address application based at least in part on the second user input.

17. The apparatus of claim 13, wherein the one or more processors are individually or collectively further operatable to execute the code to cause the apparatus to:
validate that the signature corresponds to the blockchain address application and that a destination address associated with the data is not listed on a blacklist of blockchain addresses, wherein the transaction link is displayed after the validating.

18. The apparatus of claim 13, wherein the one or more processors are individually or collectively further operatable to execute the code to cause the apparatus to:
store the transaction link, a date associated with generation of the transaction link, or both in a database.

19. The apparatus of claim 13, wherein the transaction link is configured to cause a transfer of an amount of crypto token from a smart wallet associated with a second user to a destination address associated with the data in response to selection by the second user of the transaction link.

20. A non-transitory, computer-readable medium storing code for digital token management, the code comprising instructions executable by one or more processors to:
receive, at one or more fields of a client application, data associated with a blockchain transaction, the data comprising at least a destination address;
receive, at the client application and from a user, a request to generate a transaction link associated with the blockchain transaction;
output, by the client application and to a blockchain address application after receiving the request, a transaction payload for signature by the blockchain address application, the transaction payload comprising the data associated with the blockchain transaction;
receive, from the blockchain address application, a signature associated with signing the transaction payload by a private key of the blockchain address application;
encode the data associated with the blockchain transaction and the signature in the transaction link; and
display, to the user via a graphical user interface, an indication of the transaction link, wherein the transaction link comprises the encoded data and the encoded signature.
